(19) United States
(12) Patent Application Publication
(10) Pub. No.: US 2011/0218743 A1
(43) Pub. Date: Sep. 8, 2011

(54) COMPOSITE EVALUATION

(75) Inventors: Robert Alan Smith, Farnborough (GB); Richard E. Challis, Keele (GB); Martin J. Mienczakowski, Beeston (GB)

(73) Assignee: QINETIQ LIMITED, London (GB)

(21) Appl. No.: 13/122,235

(22) PCT Filed: Oct. 7, 2009
(86) PCT No.: PCT/GB09/02392

§ 371 Date: Apr. 1, 2011

(30) Foreign Application Priority Data
Oct. 8, 2008 (GB) 0818383.2

(51) Int. Cl. G06F 19/00; G06F 17/10; G01N 29/00

(52) U.S. Cl. 702/56; 703/2; 73/632

(57) ABSTRACT

A method for evaluating a composite structure includes providing a model of said structure and locally varying a material property to determine complex reflection and transmission coefficients at said locality. From these coefficients at least one ultrasonic response characteristic for said material property can be found and compared to a measured ultrasonic response of a sample to determine a local measure of the material property. This method exploits the fact that certain material properties contribute to the ultrasonic frequency response substantially independently of one another. The frequency response of a region of porosity and of a thick resin layer in particular are evaluated. In one embodiment, the modelled responses are used to provide frequency domain basis functions for material properties, which can in turn be used in a decomposition method.

The present invention relates generally to evaluation of composite structures, and in particular to non-destructive evaluation using ultrasound techniques.

Composite materials are becoming increasingly widespread in their use, particularly in the aerospace industry. This rise in occurrence of composites has brought about the need for techniques for damage detection, characterisation and repair of composite structures. Until recently this need has been sufficiently small that it has been met by adapting methods designed for use with metals, or by attempting to extend techniques designed specifically for military purposes.

Pulse-echo ultrasonic scanning techniques have been developed to generate and measure the response of composite materials, exploiting the fact that ultrasound is reflected by acoustic impedance mismatches at boundaries between phases or materials of different compositions. Such techniques have previously been used to provide information on material properties including total fibre volume fraction (FVF) and porosity. However, there is a need to provide more detailed data for such properties.

It is therefore an object of the present invention to provide improved methods of composite evaluation.

According to one aspect of the invention there is provided a method for evaluating a composite structure comprising providing a model of said structure and locally varying a material property; determining from said model the complex reflection and transmission coefficients at said locality; deriving from said coefficients at least one ultrasonic response characteristic for said material property; and comparing a measured ultrasonic response of a sample composite structure with said at least one derived response characteristic to determine a local measure of said material property of said sample structure.

It has been found by the present inventors that certain material properties of a composite material contribute to the ultrasonic frequency response or output spectrum of that material substantially independently of one another. In particular the frequency response of a region of porosity and of a thick resin layer have been studied.

The model is an analytical model in a preferred embodiment, and complex reflection and transmission coefficients are preferably calculated using a geometric progression of coefficients at a double interface.

In one embodiment, the modelled responses are used to provide frequency domain basis functions for material properties. Basis functions can be defined as a linearly independent spanning set for a function space. In this context, basis functions are not limited to a strict mathematical definition since the basis functions referred to herein are based upon data of an empirical nature, and include for example white noise. Therefore, basis functions as referenced herein refer to functions which have a high degree of independence and, conversely, low cross correlation.

According to a further aspect of the invention there is provided a method of evaluating a composite structure comprising obtaining an ultrasonic frequency response from a volume element of said structure; decomposing said response into at least one basis function; calculating a coefficient value for each said basis function; and deriving from said coefficient value an output value for a material characteristic of said volume element.

Porosity and/or thick resin layer are material characteristics which are evaluated in one embodiment, having corresponding quarter-wave resonance and linear frequency dependence basis functions respectively. Normal fibre-resin interactions have a half-wave resonance basis function modulated by a high-frequency quarter-wave resonance which approximates to a linear frequency dependence at low frequencies.

Singular value decomposition (SVD) is preferably used for the decomposition, however alternative decomposition techniques such as a least squares decomposition can also be employed.

In one embodiment, described in greater detail below, the measured response is decomposed into three basis functions. These basis functions correspond to the normal ply/resin resonance, porosity, and thick resin layer. White noise can optionally be added as a fourth basis function. Adaptive decomposition is employed in more advanced embodiments of the invention, whereby one or more of the basis functions can be modified, and decomposition repeated in an iterative fashion. A measure of ‘goodness of fit’ can be evaluated after each decomposition to control the iterative process.

The number of basis functions can be reduced during an iterative decomposition process, in response to coefficients of certain basis functions exceeding predefined thresholds. The decomposition algorithm of one embodiment of the invention excludes a given basis function from subsequent iterations if the coefficient for that basis function falls below zero. The coefficient value for that basis function is preferably then set to zero.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention extends to methods, apparatus and/or use substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:

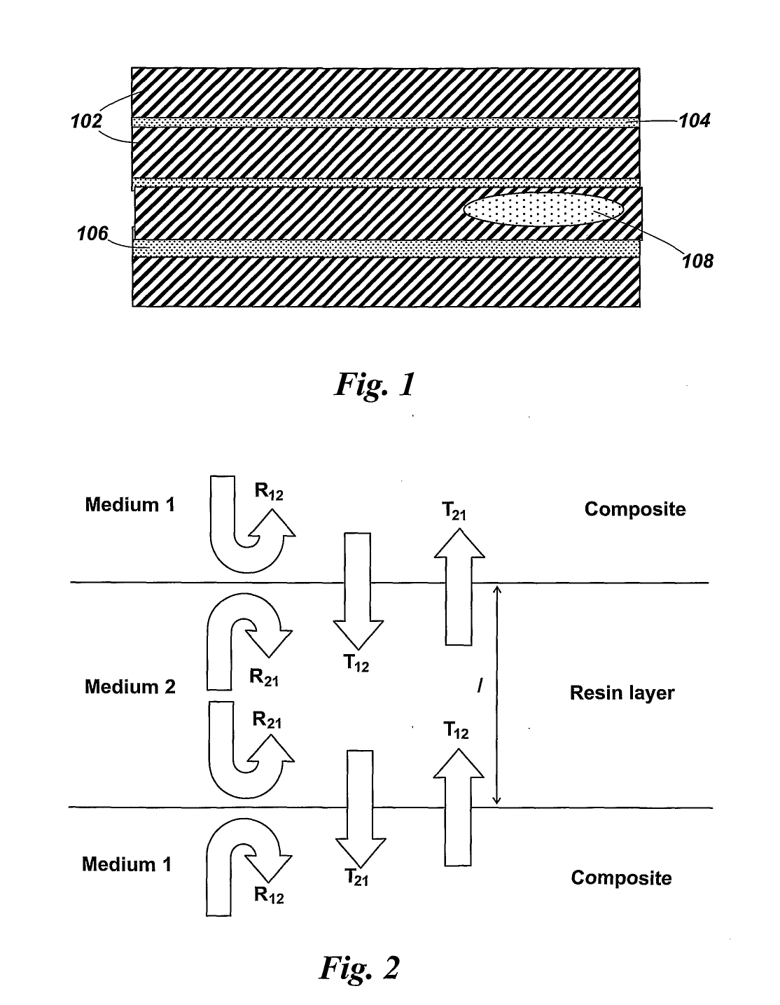

FIG. 1 illustrates a carbon fibre cross section containing defects;

FIG. 2 illustrates reflection and transmission coefficients at a pair of ply interfaces;

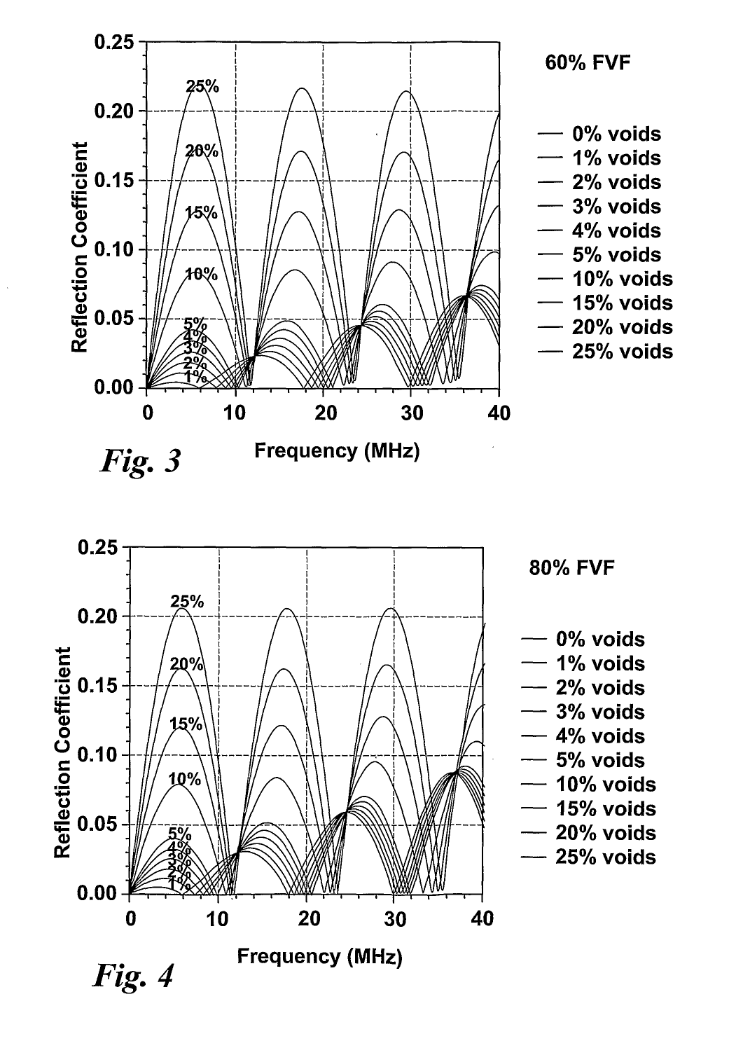

FIGS. 3 and 4 are graphs of modelled reflection coefficient with increasing porosity;

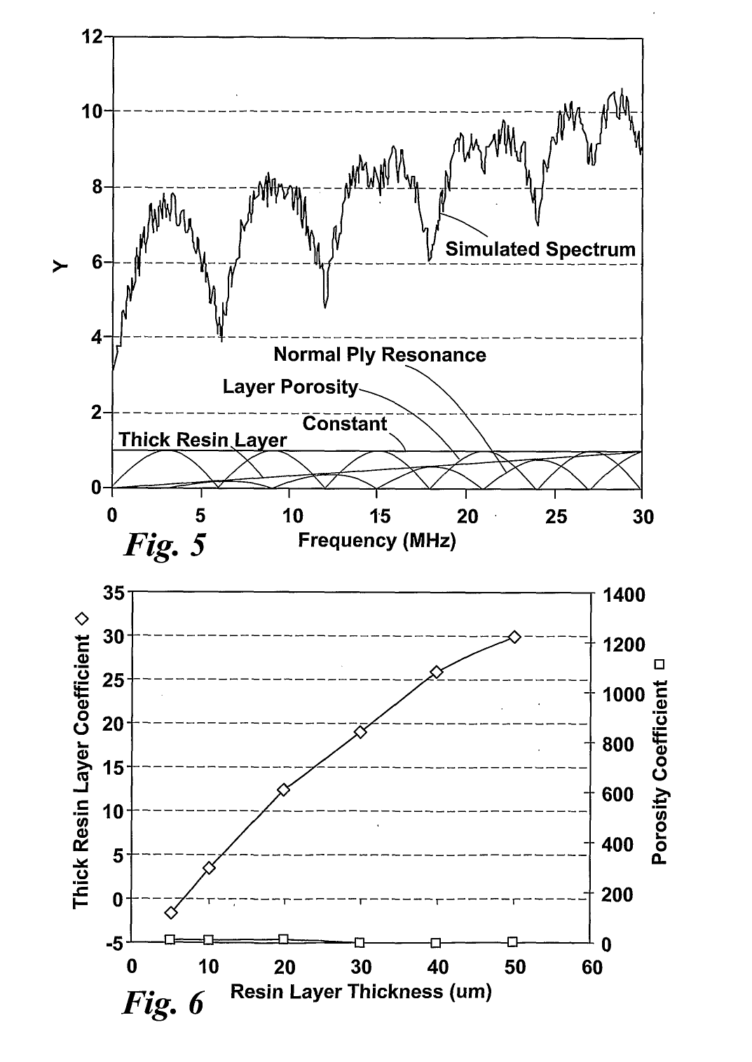

FIG. 5 is a graph showing basis functions;

FIGS. 6 to 12 illustrate porosity and thick resin coefficients;

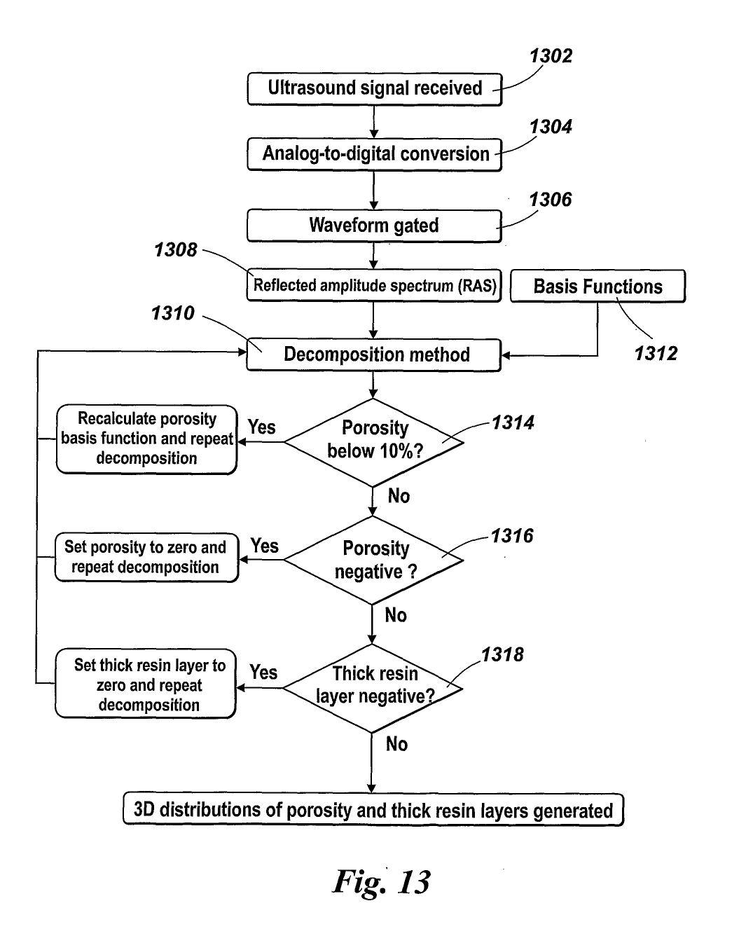

FIG. 13 is a flow diagram of an iterative decomposition method.

Turning to FIG. 1, a typical carbon fibre composite material consists of layers 102 of carbon fibres embedded in a resin matrix, which fibres may be arranged in parallel tows or interwoven for example. There is often a thin layer 104 of epoxy resin existing between layers 102 of differing fibre orientations. The carbon fibre layers or plies are typically much thicker than the resin layers, for example carbon fibre plies having a thickness of approx 0.125 mm might be separated by a resin layer of thickness 0.005 mm. Such carbon fibre structures are susceptible to a number of structural defects, which may arise during manufacture for example. A defect is shown at 106 in the form of a thick resin layer. Such a defect can be characterised by its thickness, which might, in this example be 0.02 mm or roughly four times the intended thickness, and may adversely affect the structural properties of the material. A further possible defect; a region of porosity 108 is illustrated in one of the resin layers. Such a region may be characterised by a porosity percentage, being the volume fraction of entrapped air or gas.

The mechanism of ultrasound reflection in carbon fibre composites allows the resin layer situated between two composite layers to be treated as a single interface for the purposes of this application, with the amplitude of the reflected signal varying substantially linearly with the resin thickness (subject to appropriate parameters). The composite plies themselves are also resonant layers but their greater thickness having lower resonant frequency.

A model has been developed to describe a combination of two interfaces in terms of complex transmission and reflection coefficients, such that the combination can then be treated as a single interface characterised by those coefficients. For normal incidence plane waves at a single interface, pressure reflection and transmission coefficients, r and t can be expressed as:

$$r = \frac{{Z}_{2} - {Z}_{1}}{{Z}_{2} + {Z}_{1}}$$

$$t = \frac{2 {Z}_{2}}{{Z}_{2} + {Z}_{1}}$$

And intensity reflection and transmission coefficients R and T can be expressed as:

$$R = \frac{{( {Z}_{2} - {Z}_{1} )}^{2}}{{( {Z}_{2} + {Z}_{1} )}^{2}}$$

$$T = \frac{4 {Z}_{2} {Z}_{1}}{{( {Z}_{2} + {Z}_{1} )}^{2}}$$

If incident pressure at an interface can be expressed as:

pᵢ(t,x)=Aᵢe^{i(ωt-k}^{₁}^{x)-α}^{₁}^{x}

Where:

p Acoustic Pressure

A Pressure Amplitude at x=0 (ply interface)

α₁ α₂ Attenuation Coefficient (nepers/m) in medium 1, 2

k₁ k₂ Wavenumber (2πf/c) in medium 1, 2

then reflected and transmitted pressure are expressed respectively as:

pᵣ(t,x)=Aᵣe^{i(ωt+k}^{₁}^{x)-α}^{₁}^{x} p(t,x)=Aₜe^{i(ωt-k}^{₂}^{x)-α}^{₂}^{x}

FIG. 2 illustrates multiple reflections and transmissions at an interface pair which may be modelled to derive complex reflection and transmission coefficients. This is achieved by employing a Geometric Progression (GP) principle, arⁿ, where the sum to infinity (n→∞) is well defined provided the multiplier, r, meets the condition: |r/<1, to give overall complex reflection and transmission coefficients as:

$$r = {r}_{12} + {t}_{12} {t}_{21} {r}_{21} {e}^{- 2 l ( i {k}_{2} + {α}_{2} )} {\sum }_{n = 0}^{∞} {[ {r}_{21}^{2} {e}^{- 2 l ( i {k}_{2} + {α}_{2} )} ]}^{n}$$

$$t = {t}_{12} {t}_{21} {\sum }_{n = 0}^{∞} {[ {r}_{21}^{2} {e}^{- 2 l ( i {k}_{2} + {α}_{2} )} ]}^{n}$$

If the interface pairs are symmetrical (ie they have the same medium either side of them as in FIG. 2) then two such interface pairs can then be combined in the same way. The frequency dependence of the ultrasonic response, and hence the impulse response of the structure, will be contained in those complex reflection coefficients.

The model is extended to allow the inclusion of changes in material properties due to porosity. Local mixture rules are used to calculate local changes in modulus, ultrasonic velocity and density, thus giving the averaged changes in impedance across each layer. A porous layer results in increased attenuation and frequency dependence is linked to pore size. Thus the size of the individual pores has to be specified in order to determine the frequency-dependent attenuation. In this example, no allowance was made for the return of backscattered energy to the transducer except in the sense of changes in reflection coefficient at the composite-resin boundaries due to changes in average impedance of the composite layer due to porosity.

In order to simulate the frequency response from a small volume element, a simple 3-layer system (resin-composite-resin, embedded in composite) was investigated as this could represent the approximate size in terms of depth of a volume element. Examples of the frequency-response variations with the inclusion of varying amounts of porosity in the single composite layer in the middle of the volume element are given in FIGS. 3 and 4 for 60% and 80% fibre volume fraction. It can be seen that increasing levels of porosity increase the reflection coefficient and change the nature of the ply resonance from a ½-wave resonance to a ¼-wave resonance. This is thought to be due to the resin and composite impedances being very similar, so a very small lowering of the impedance of the composite layer results in a reversal of the resin-composite reflection coefficient, thus changing the nature of the reflection in the thin resin layer. However, this hypothesis does not constitute a limiting characteristic of the invention.

In order to model a thick resin layer, including an adhesive bondline, the model was modified to incorporate an array of thicknesses for the inter-ply layers instead of a single value for all layers. The model already includes arrays for both the thickness and fibre volume fraction of the ply layers. The default thickness for all the inter-ply layers is the single value specified. A new thickness can then be provided for one specified inter-ply layer. The model is adapted automatically to adjust the adjacent composite ply layer in thickness and fibre volume fraction to retain the same ply spacing and total volume of fibres in the local region.

By modelling structural features such as local porosity and thick resin layer in this way, modelled ultrasonic responses can be obtained from the complex reflection and transmission coefficients. These modelled responses can then be used as references against which measured responses from a reference sample are compared to determine values for that reference sample.

The following set of basis functions were produced based on modelled responses:
A constant representing white noise etc: N=a₀.
A half-wave resonance amplitude modulated by a linear slope with frequency. These functions are multiplied to represent a normmal ply resonance: S(ω)R(ω, tₙₒᵣₘ), where S(ω)=a₁|cos(ω/ω₀)|; and R(ω, tₙₒᵣₘ)=(ω/2π)·10⁻⁶
A linear slope with frequency to represent the low-frequency part of a thick resin layer response: C(ω, t_{thick})=a₂(ω/2π)·10⁻⁶
A quarter-wave resonance to represent layer porosity: P(ω)=a₃|sin(ω/ω₀)|
   Thus the reflected amplitude spectrum can be represented by the following combination of modelled basis functions:

F(ω)=A₀T²(ω)[S(ω)R(ω,tₙₒᵣₘ)+C(ω,t_{thick})+P(ω)]+N

Where T(ω) is the transducer response.

It can be seen that the transducer response is squared to account for both transmission and reception of the signal. It can also be seen that the thick resin layer basis function C is not multiplied by linear function S because modelling indicates that a single thick resin layer is substantially independent of ply resonances.

By way of a simplified illustration, a simulated signal spectrum is shown at 502 in FIG. 5. Also shown in FIG. 5 are the individual basis functions into which the simulated spectrum is to be decomposed.

In order to decompose a measured response into basis functions, singular value decomposition (SVD) is used. Even in the presence of noise, SVD accurately determines the coefficients of the basis functions as shown by the figures below which correspond to the graph of FIG. 5.

| | Basis functions: | | | |
|---|---|---|---|---|
| | Constant | C(ω, t_{thick}) | P(ω) | S(ω)R(ω, tₙₒᵣₘ) |
| Input coefficients: | 2.50 | 1.70 | 4.30 | 3.90 |
| SVD output coefficients: | 2.98 | 1.80 | 4.29 | 3.84 |

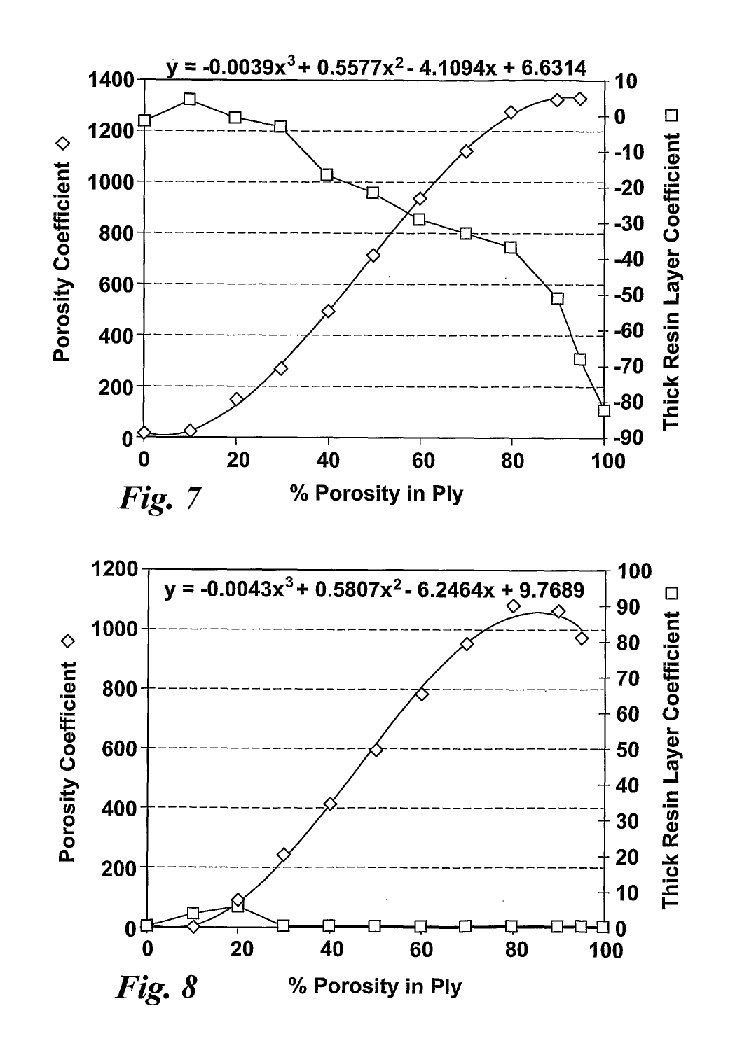

The method was further evaluated using modelled data for 32×0.125 mm plies. FIG. 6 shows the dependence of coefficients on thick resin layers while FIG. 7 shows the dependence on porosity. It can be seen that for thick resin layers the corresponding coefficient is substantially linear while cross talk with the porosity coefficient is extremely low, ie the two basis functions are substantially independent as desired. Turning to FIG. 7, it can be seen that the porosity coefficient is substantially linear also, however there is crosstalk with the thick layer coefficient, which becomes negative with increasing porosity.

The decomposition method was modified accordingly, to limit the minimum thick resin layer coefficient to zero. In an iterative algorithm, if the coefficient does become negative, it is set to zero and the decomposition re-run without the thick layer basis function. This method provides the result shown in FIG. 8, where it can be seen that the thick resin layer coefficient is limited to low values, and the porosity coefficient is substantially linear from porosity values of between 10% and 80%.

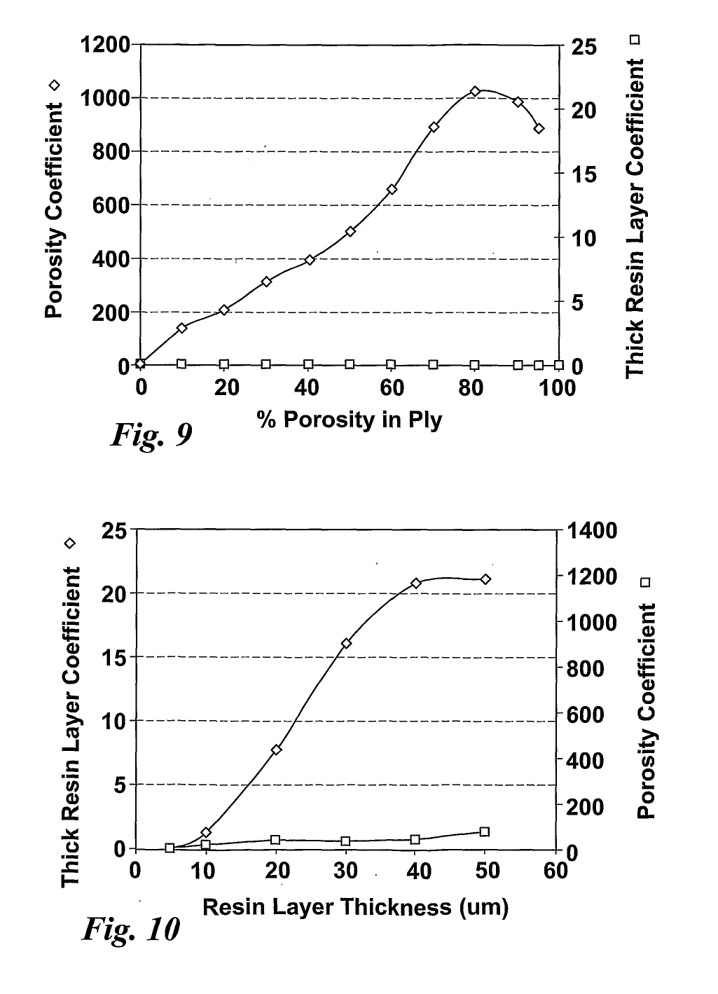

From FIGS. 3 and 4 it can be seen that below 10% porosity the resonant frequencies decrease, approaching the resonance of the normal fibre-resin structure, and explains why porosities below 10% were not detected in FIG. 8. An adaptive method was introduced to lower the resonant frequencies of the porosity basis function to ascertain whether a better fit is achieved. The result is shown in FIGS. 9 and 10 where it is clear that porosity below 10% can now be detected and measured.

A frequency dependent correction can be made for the depth of a given volume element, by using the model to predict what incident spectrum arrives at each volume element:

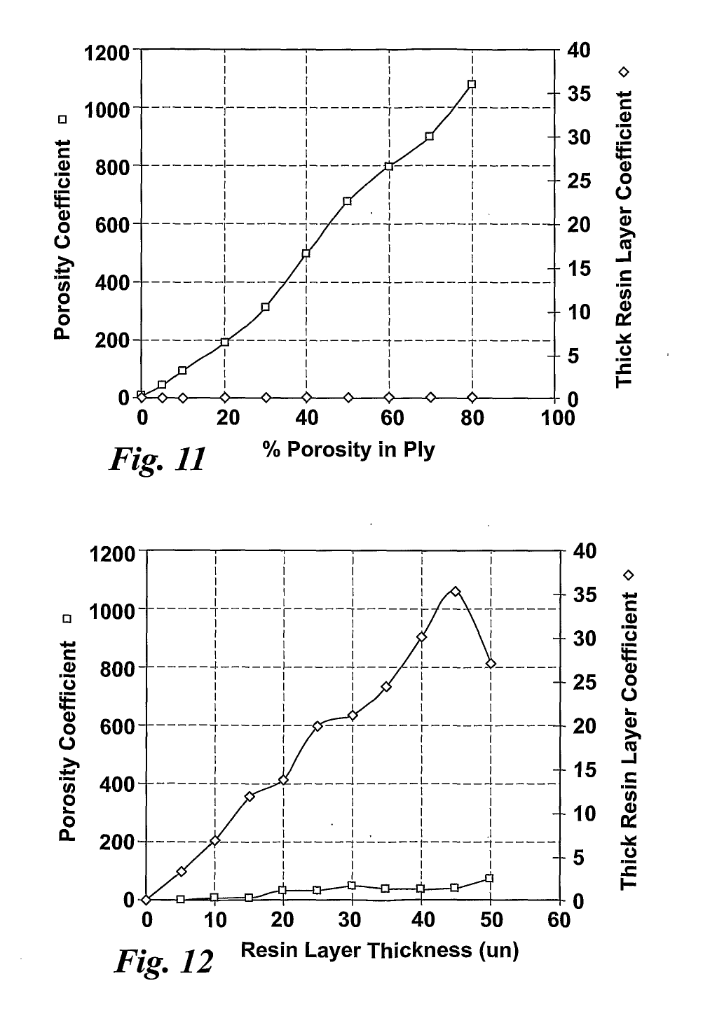

F(ω)=a₀N+A₀T²(ω)D(ω,d)[a₁S(ω)R(ω,tₙₒᵣₘ)+a₂C(ω,t_{thick})+a₃P(ω)]

where d is the depth in the structure, or the number of plies passed, and D(ω,d) is calculated for each depth or ply, and A₀T²(ω)D(ω,d) is the incident spectrum at each depth or ply d. The results for this correction are illustrated in FIGS. 11 and 12. Referring to FIG. 13, at 1302 an ultrasonic scanner (for example Diagnostic Sonar's Flawlnspecta®) can be used to provide measured responses for a material under test over a range of inspection frequencies covering 0-20 MHz. The received signal undergoes analogue to digital conversion at 1304, and is gated using a short gate at 1306 to derive the response for a particular volume element. This signal is transformed into the frequency domain to provide the reflected amplitude spectrum (RAS) at 1308.

A decomposition is performed at 1310, using for example SVD, and using basis functions 1312 derived as explained above. The decomposition derives coefficient values for each of the basis functions, which can be calibrated against modelled results to provide values such as percentage porosity and resin layer thickness. At 1314 the porosity level is tested, and if it is below 10% the porosity basis function is recalculated with a lower resonant frequency (see FIGS. 3 and 4) and the decomposition repeated. Porosity is checked for negative values at 1316, and if negative values are returned then the porosity is set to zero and the decomposition repeated without the porosity basis function. Finally at 1318 Thick resin layer values are checked to determine whether they are negative. If they are, the thick resin layer value is set to zero and the decomposition repeated without the thick resin layer basis function either, in a similar manner to 1316 above. A similar approach is taken if the normal ply resonance coefficient is negative, which can happen for a porous layer.

At the end of the process, where responses for multiple localities (either by virtue of gating, sensor arrangement/orientation or both) have been obtained and decomposed in this way, the 3D distribution of porosity and thick resin layers are generated.

It will be understood that the present invention has been described above purely by way of example, and modification of detail can be made within the scope of the invention. While an example of evaluation of a carbon fibre composite has been provided, the method is equally applicable to other composites such as metal matrix composites or glass-fibre aluminium reinforced epoxy (GLARE) for example, and other inhomogeneous materials.

Each feature disclosed in the description, and (where appropriate) the claims and drawings may be provided independently or in any appropriate combination.

1. A method of evaluating a composite structure comprising
obtaining an ultrasonic frequency response from a volume element of said structure;
decomposing said response into at least one basis function;
calculating a coefficient value for each said basis function; and
deriving from said coefficient value an output value for a material characteristic of said volume element.

2. A method according to claim 1, wherein said characteristic is local porosity.

3. A method according to claim 1, wherein said characteristic is thick resin layer.

4. A method according to claim 2, wherein the basis function corresponding to local porosity is a quarter wave resonance.

5. A method according to claim 3, wherein the basis function corresponding to thick resin layer is a linear slope with frequency.

6. A method according to claim 1, wherein said decomposition is performed by singular value decomposition (SVD).

7. A method according to claim 1, wherein said frequency response is decomposed into at least three basis functions.

8. A method according to claim 1, wherein one or more basis functions are modified adaptively during decomposition.

9. A method according to claim 8, wherein a basis function is removed from decomposition if its coefficient becomes negative.

10. A method for evaluating a composite structure comprising
providing a model of said structure and locally varying a material property;
determining from said model the complex reflection and transmission coefficients at said locality;
deriving from said coefficients at least one ultrasonic response characteristic for said material property; and
comparing a measured ultrasonic response of a sample composite structure with said at least one derived response characteristic to determine a local measure of said material property of said sample structure.

11. A method according to claim 10, wherein said model is an analytical model.

12. A method according to claim 10, wherein said measured ultrasonic response is compared with a combination of derived response characteristics.

13. A method according to claim 10, wherein more than one material property is varied.

14. A computer readable medium having stored thereon computer implementable instructions for causing a programmable computer to perform a method according to claim 1.
